(19) United States
(12) Patent Application Publication
(10) Pub. No.: US 2011/0159960 A1
(43) Pub. Date: Jun. 30, 2011

(54) MOBILE HANDHELD UNIT

(76) Inventors: Hiromu UESHIMA, Shiga (JP); Hitoshi Suzuki, Shiga (JP); Yuuki Konno, Shiga (JP)

(21) Appl. No.: 12/836,625

(22) Filed: Jul. 15, 2010

(30) Foreign Application Priority Data
Jul. 17, 2009 (JP) 2009-168913

(51) Int. Cl. A63F 13/06

(52) U.S. Cl. 463/37

(57) ABSTRACT

The mobile handheld terminal comprises: a state sensor detecting a self-posture in three-dimensional space; and a position-detecting part detecting a self-position. When such mobile handheld terminal 1 is located in an insect-habitation field, the mobile handheld terminal 1 displays on a display: a scope image; and an insect image corresponding to an insect as a virtual subject which is assigned there. And the mobile handheld terminal controls video image on the display on the basis of the posture thereof and considers that the insect is captured when the insect image goes into the scope image.

### BACKGROUND OF THE INVENTION

1. Field of the Invention

The present invention relates to a mobile handheld terminal and related arts thereof operable to perform an event according to position thereof.

2. Description of the Related Art

The patent document (Japanese Unexamined Patent Application 2006-25865) discloses a virtual-subject-capturing game system. In this system, a user has an insect net containing a RF tag and moves it closer to a RF reader/writer which is attached to a main body of a game apparatus in accordance with a position of a virtual insect. A game controlling unit records information about the insect which the user captured virtually by RF reader/writer.

### SUMMARY OF THE INVENTION

However, in the system of patent document 1, it is too easy for a player to capture the insect because it is only making the insect net closer to the RF reader/writer. Therefore, it is easy to get tired of, and it is not enough as a game or an entertainment.

It is therefore an object of the present invention to provide a mobile handheld terminal and its related arts which it is hard to get tired of and it is enough fun as a game or an entertainment.

According to the first aspect of the present invention, a mobile handheld terminal comprising: a state detecting unit operable to detect a state of the mobile handheld terminal in three-dimensional space; a position detecting unit operable to detect a position of the mobile handheld terminal; a determining unit operable to determine whether or not the detected position exists in the predetermined field; and an event performing unit operable to perform an predetermined event and to control progress of the predetermined event on the basis of the state of the mobile handheld terminal, in the case where the determining unit determines that the detected position exists in the predetermined field.

In accordance with this configuration, the progress of the event which is performed when the mobile handheld terminal is located in the predetermined field is controlled based on the state (Including a posture) of the mobile handheld terminal in three-dimensional space. In other words, a user can control the progress of the event which is performed in the predetermined field, by moving the mobile handheld terminal or changing the posture of it. As a result, it is possible to provide a content which is according to the self-position, and it is hard to get tired of and is enough fun as game or an entertainment than in the case where the mobile handheld terminal cannot control the event or in the case where it can control the event but is operated in a resting state.

This mobile handheld terminal further comprising a displaying unit, wherein the event performing unit performs a game as the event which displays video image on the displaying unit, and controls progress of the game on the basis of the state of the mobile handheld terminal.

In accordance with this configuration, the progress of the game which is performed when the mobile handheld terminal is located in the predetermined field is controlled based on the state (Including the posture) of the mobile handheld terminal in three-dimensional space. In other words, a user can control the progress of the game which is performed in the predetermined field, by moving the mobile handheld terminal or changing the posture of it. As a result, it is possible to provide a game content which is according to the self-position, and it is hard to get tired of and is enough fun as game or an entertainment than in the case where the mobile handheld terminal cannot control the game or in the case where it can control the game but is operated in a resting state.

In this mobile handheld terminal, wherein the game is a game to capture a virtual subject assigned to the predetermined field, wherein the event performing unit displays an image representing the virtual subject on the displaying unit, and determines on the basis of the state of the mobile handheld terminal whether or not the virtual subject is captured.

In accordance with this configuration, a player tries to capture the virtual insect by moving the mobile handheld terminal or changing the posture of it. As a result, it is possible to provide a capturing-game which is according to the self-position, and it is hard to get tired of and is enough fun as game or an entertainment than in the case where a capture is automatically done when the mobile handheld terminal arrives at the predetermined field or in the case where the mobile handheld terminal is operated in a resting state.

According to the second aspect of the present invention, an event controlling method comprising the steps of: detecting a state of a mobile handheld terminal in three-dimensional space; detecting a position of the mobile handheld terminal; determining whether or not the detected position exists in a predetermined field; and performing a predetermined event and controlling progress of the predetermined event on the basis of the state of the mobile handheld terminal, in the case where it is determined in the determining step that the detected position exists in the predetermined field. In accordance with this configuration, a similar advantage as the mobile handheld terminal according to the first aspect can be gotten.

According to the third aspect of this invention, the computer program lets a computer perform the event control method according to the second aspect above. In accordance with this configuration, similar advantage as the imaging apparatus according to the above first aspect can be gotten.

According to the fourth aspect of this invention, the recording medium records a computer program of the third aspect. In accordance with this configuration, similar advantage as the mobile handheld terminal according to the first aspect can be gotten.

### BRIEF DESCRIPTION OF THE DRAWINGS

The novel features of the invention are set forth in the appended claims. The invention itself, however, as well as other features and advantages thereof, will be best understood by reading the detailed description of specific embodiments in conjunction with the accompanying drawings, wherein:

FIG. 1 is an explanatory view of a capturing-game system as a self-position using system in the embodiment of this invention.

FIG. 2 is a plan view of a mobile handheld terminal 1 of FIG. 1.

FIG. 3 is a flowchart showing an example of a flow of a main routine which a processor 41 of FIG. 2B performs.

FIG. 4 is a flowchart showing an example of a flow of a field-setting process of step S1 of FIG. 3.

FIG. 5 is a flowchart showing an example of a flow of a first timer process which the processor 41 of FIG. 2B performs.

FIG. 6 is a flowchart showing an example of a flow of a pedometer process which the processor 41 of FIG. 2B performs.

FIG. 7 is a flowchart showing an example of a flow of a position-detecting process which the processor 41 of FIG. 2B performs.

FIG. 8 is a flowchart showing an example of a insect-capturing process of step S11 of FIG. 3.

FIG. 9 is a flowchart showing an example of a flow of a process which is following step S129 of FIG. 8.

FIG. 10 is a flowchart showing an example of a flow of a process after “YES” is determined in step S149 of FIG. 9.

FIG. 11 is an example view of an insect habitation table 61 stored in the external memory 43 of FIG. 2B.

FIG. 12 is an example view of a screen displayed when an insect image 7 appears in step S11 of FIG. 3.

FIG. 13 is an example view of a screen displayed when the insect image 7 is located in a scope 5 in step S11 of FIG. 3.

FIG. 14 is an explanatory view of a first game program performed in step S91 of FIG. 6.

FIG. 15 is an explanatory view of a second game program performed in step S91 of FIG. 6.

FIG. 16 is a diagram showing an example of a content-providing system using a capturing -game system of the present embodiment.

FIG. 17 is an example view of an information screen of a WEB site provided to a user terminal 83 from a server 81 of FIG. 16.

FIG. 17 is an example view of an information screen of a WEB site provided to a user terminal 83 from a server 81 of FIG. 16.

FIG. 19 is another example view of the picture book screen of the WEB site provided to the user terminal 83 from the server 81 of FIG. 16.

FIG. 19 is another example view of the picture book screen of the WEB site provided to the user terminal 83 from the server 81 of FIG. 16.

FIG. 21 is another example view of the insect cage screen of the WEB site provided to the user terminal 83 from the server 81 of FIG. 16.

FIG. 21 is another example view of the insect cage screen of the WEB site provided to the user terminal 83 from the server 81 of FIG. 16.

### DESCRIPTION OF THE PREFERRED EMBODIMENTS

In what follows, an embodiment of the present invention will be explained in conjunction with the accompanying drawings. Meanwhile, like references indicate the same or functionally similar elements throughout the drawings, and therefore redundant explanation is not repeated.

The self-position-using system of the present embodiment assigns virtual fields to real fields. In addition, it assigns virtual subjects to the virtual fields.

In the following example, the virtual subject is an insect. In the following explanation, “insect” normally means the insect as the virtual subject. In this case the virtual field is a habitat of the insect. And a player operates the mobile handheld terminal in real fields which are assigned the (virtual) habitats of the insects and he captures or collects the insects which inhabit in (are assigned to) the (virtual) habitats on a display of the mobile handheld terminal.

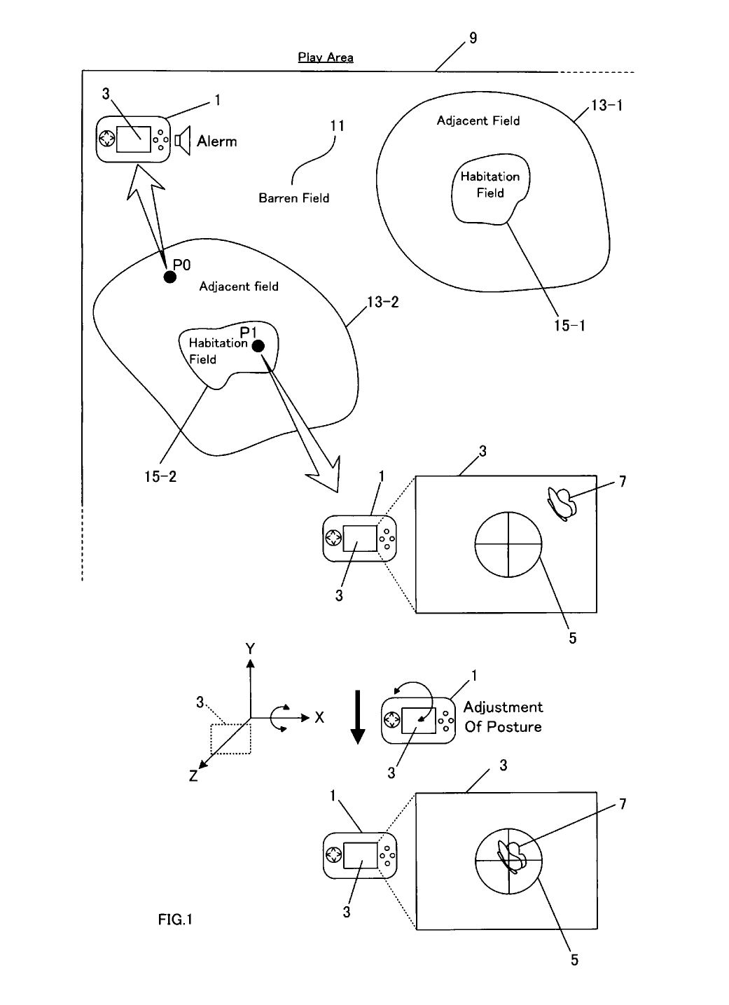

FIG. 1 is the explanatory view of the capturing-game (collecting-game) system as the self-position-using systems in the embodiment of the present invention. Referring to FIG. 1, this capturing-game system is performed in a play area 9. The play area 9 is the real field. In the play area 9, the “N” real fields are set in advance (“N” is an integer not less than one. However, in the present invention, “N” is set as an integer not less than two.) Among the “N” real fields, the “M” real fields are set as a valid field and the “N-M” real fields are set as a invalid field (“M” is an integer not less than one. However, in the present invention, “M” is set as an integer not less than two.). And each of “M” valid fields is assigned the virtual field.

So, in the play area 9, the insect-habitation fields 15-1, 15-2, . . . , and 15-M are set, and the adjacent fields 13-1,13-2, . . . , and 13-M are set. In the following description, the insect-habitation fields 15-1, 15-2, . . . , and 15-M are referred to simply as the “insect-habitation field 15” unless it is necessary to distinguish them. The adjacent fields 13-1,13-2, . . . , and 13-M are referred to simply as the “adjacent field 13” unless it is necessary to distinguish them.

In addition, a field other than the valid field in the play area 9 is referred to as a barren field 11. Therefore, the barren field 11 includes not only the invalid field but also the field other than the real field of the play area 9.

When the mobile handheld terminal 1 moving with a player is located in, for example, a spot “P0” of the adjacent field 13-2, the mobile handheld terminal 1 generates and outputs an alarm indicating that the insect-habitation field 15-2 exists near. And the mobile handheld terminal 1 displays video image to capture the insect on the display 3 by first-person viewpoint when the mobile handheld terminal 1 moves to a spot “P1” of the insect-habitation field 15-2.

### Performance of Event

In other words, the mobile handheld terminal 1 displays on the display 3 the insect image 7 which stops or moves around on background image. In this case, the mobile handheld terminal 1 displays the scope 5 fixedly in the center of the display 3. The scope 5 corresponds to the viewpoint of the player.

And the mobile handheld terminal 1 scrolls the background image and the insect image 7 on the display 3 according to the posture thereof. (Control of Event Process) The scroll of the background image and the insect image 7 corresponds to the movement of the viewpoint, because the scope 5 is fixed at the center of the screen.

The player adjusts the posture of the mobile handheld terminal 1 so that the insect image 7 goes into the scope 5. When the insect image 7 goes into the scope 5, the mobile handheld terminal 1 considers that the insect corresponding to the insect image 7 is captured. And the mobile handheld terminal 1 registers such insect in a captured insect list.

In this way, the player tries to capture the insect by moving the mobile handheld terminal 1 and changing the posture thereof. As this result, it is possible to provide the capturing-game which is according to the self-position, and it is hard to get tired of and is enough fun as game or an entertainment than in the case where the capture is automatically done when the mobile handheld terminal arrives at the predetermined field or in the case where the mobile handheld terminal is operated in a resting state (e.g. operation by switch).

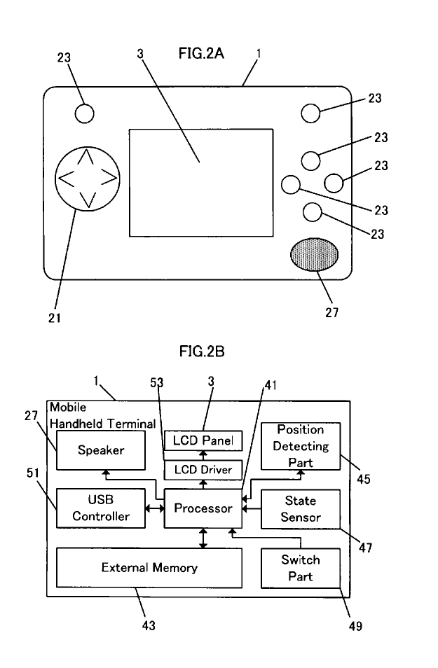

FIG. 2A is the plan view of the mobile handheld terminal 1 of FIG. 1. Referring to FIG. 2A, the mobile handheld terminal 1 comprises LCD (Liquid Crystal Display) panel 3 (in the above explanation, referred to as “the display 3”) in the vicinity of the surface center. Arrow keys 21 are located on the left of the LCD panel 3, and a switch 23 is located on the upside of the arrow keys. The five switches 23 are located on the right of the LCD panel 3, and a speaker 27 is located on the underside of the switches 23.

FIG. 2B is the diagram showing the electrical constitution of the mobile handheld terminal 1. Referring to FIG. 2B, the mobile handheld terminal 1 comprises the processor 41, the external memory 43, a position-detecting part 45, a state sensor 47, a switch part 49, a USB (Universal Serial Bus) controller 51, a LCD driver 53, the LCD panel 3 and the speaker 27.

The processor 41 is connected to the external memory 43. The external memory 43 includes necessary memory depending on the specifications of the system, for example, a ROM, a EEPROM (Electrically Erasable Programmable Read Only Memory), a RAM and a semiconductor memory such as a flash memory, a ROM cartridge, a RAM memory cartridge with battery backup, a flash memory cartridge, a nonvolatile RAM cartridge, or any combination thereof. Incidentally, the external memory 43 is an example of the recording medium.

The external memory 43 includes a program area, an image data area and a sound data area. In the program area, control program to let the processor 41 perform various processes (process in the following flowchart) is stored.

In the image data area, image data necessary to generate a video signal is stored. In the sound data area, sound data to generate an audio signal such as a voice, sound effect and music etc. is stored.

The processor 41 performs the control program of the program area, reads the image data of the image data area and the sound data of the sound data area, performs a necessary process, and generates the video signal and the audio signal. Each of the video signal and the audio signal is given to the LCD driver 53 and the speaker 27.

In addition, the insect-habitation table 61 of FIG. 11 is stored in the external memory 43.

The LCD driver 53 drives the LCD panel 3 and displays the video image according to the video signal given from the processor 41. In addition, the speaker 27 outputs a sound depending on the audio signal given from the processor 41. The switch part 49 includes the arrow keys 21 and switches 23, and key status thereof are given to the processor 41. The processor 41 performs processes depending on the received key status. The USB controller 51 receives the control of the processor 41 and communicates with a provider's terminal 75 to be described below and transmits and receives data.

As far as the position-detecting part 45 can detect an absolute position or an relative position of the mobile handheld terminal 1, its detecting method is not limited. For example, the position-detecting part 45 may be a GPS receiver in the case where it detects the absolute position of the mobile handheld terminal 1. In this case, the processor 41 processes and analyzes a signal from the GPS receiver and calculates the position of the mobile handheld terminal, on the basis of a widely known position-detecting algorithm.

For another example, the position-detecting part 45 may be a radio receiver in the case where it detects the relative position of the mobile handheld terminal 1. In this case, plural transmitters are placed in the play area 9, for example, a radio transmitter, a base station of a mobile phone, or access point of a wireless-LAN .etc. Each transmitter is assigned peculiar identification information (transmitter ID) and transmits it.

And the processor 41 receives the transmitter ID, decodes it and calculates the self-position. In this case, processor 41 may determine the self-position by any combination of plural transmitter IDs, or, processor 41 may determine the self-position by one transmitter ID.

For further example, the position-detecting part 45 may be a RF tag in the case where it detects the relative position of the mobile handheld terminal 1. In this case, plural RF readers/writers are placed in the play area 9. And, the RF reader/writer writes the position of the RF reader/writer in the RF tag. For further example, the position-detecting part 45 may be a RF reader/writer. In this case, plural RF tags are placed in the play area 9. And the RF reader/writer reads position information stored in each RF tag.

As far as the state sensor 47 can detect the states (including the posture) of the mobile handheld terminal 1 in three-dimensional space, a type of the sensor is not limited. For example, the state sensor 47 may be an acceleration sensor, a gyro sensor, a direction sensor or a tilt sensor, or any combination thereof. In the present embodiment, the state sensor 47 is a triaxiality acceleration sensor.

Although not shown in the figure, the processor 41 comprises a central processing unit (hereinafter referred to as the “CPU”), a graphics processing unit (hereinafter referred to as the “GPU”), a sound processing unit (hereinafter referred to as the “SPU”), a geometry engine (hereinafter referred to as the “GE”), an external interface block, a main RAM, an A/D converter (hereinafter referred to as the “ADC”) and so forth.

The CPU performs the process relating to graphics operations, which are performed by running the program stored in the external memory 43, such as the calculation of the parameters required for the expansion, reduction, rotation and/or parallel displacement of the respective objects and the calculation of eye coordinates (camera coordinates) and view vector. In this description, the term “object” is used to indicate a unit which is composed of one or more polygons or sprites and to which expansion, reduction, rotation and parallel displacement transformations are applied in an integral manner.

The GPU serves to generate a three-dimensional images composed of polygons and sprites on a real time base, and converts it into an analog composite video signals. The SPU generates PCM (pulse code modulation) wave data, amplitude data, and main volume data, and generates analog audio signals from them by analog multiplication. The GE performs geometry operations for displaying a three-dimensional image. Specifically, the GE executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The external interface block is an interface with peripheral devices (the LCD driver 53, the switch part 49, the USB controller 51, the position-detecting part 45 and the state sensor 47 in the case of the present embodiment) and includes programmable digital input/output (110) ports of 24 channels. The ADC is connected to analog input ports of 4 channels and serves to convert an analog signal, which is input from an analog input device through the analog input port, into a digital signal. The main RAM is used by the CPU as a work area, a variable storing area, a virtual memory system management area and so forth.

Next, the process performed by the processor 41 will be explained with reference to flowcharts.

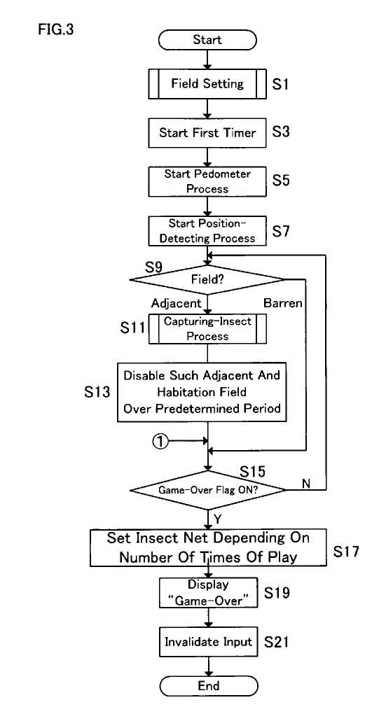

FIG. 3 is the flowchart showing an example of the flow of the main routine that the processor 41 of FIG. 2B performs. Referring to FIG. 3, in step S1, the processor 41 sets the insect-habitation field 15 and the adjacent field 13 in the valid field. In step S3, the processor 41 starts the first timer. The first timer is a timer measuring play time. In the present embodiment, the play time is set for 60 minutes. In step S5, the processor 41 starts the pedometer process. In step S7, the processor 41 starts the position-detecting process for the mobile handheld terminal 1.

In step S9, the processor 41 determines in which field the mobile handheld terminal 1 is located. In other words, the processor 41 proceeds to step S11 in the case where the mobile handheld terminal 1 is located in the adjacent field 13, and the processor 41 proceeds to step S15 in the case where it located in the barren field 11.

In step S11, the processor 41 performs the process for capturing the insect.

### Performance of Event

After finishing the insect-capturing process in an insect-habitation field 15 corresponding to an adjacent field 13, in step S13, the processor 41 disables such adjacent field 13 and its corresponding insect-habitation field 15 only over a predetermined period (e.g. ten minutes). Therefore, the processor 41 does not perform the insect-capturing process of step S11 in such adjacent field 13 and its corresponding insect-habitation field 15 until such predetermined time passes. And therefore, even if the mobile handheld terminal 1 is located in the adjacent field 13 or its corresponding insect-habitation field 15 while the predetermined time, the processor 41 skips step S11 and S13 and proceeds to step S15.

In step S15, the processor 41 determines whether or not an game-over flag is ON, and the processor 41 proceeds to step S17 if ON, and the processor 41 returns to step S9 if OFF. This game-over flag is a flag which becomes ON when sixty minutes pass since the first timer started in step S3.

In the case where the game-over flag is ON, in step S17, the processor 41 sets an insect net depending on a number of times of the play. For example: when the first play ends, the processor 41 sets the long insect net which makes the capture of the insect in the high place become easier; when the second play ends, the processor 41 sets the insect net which makes the capture of the insect in water become easier; and when the third play ends, the processor 41 sets the insect net which makes the capture of the insect become easier in all situation. Incidentally, when the first play starts, the processor 41 sets the standard insect net.

In step S19, the processor 41 displays video image showing the game-over on the display 3. And, in step S21, the processor 41 invalidates (does not accepted) inputs from the arrow keys 21 and the switches 23, and then finishes the process.

FIG. 4 is the flowchart showing an example of a flow of the field-setting process of step S1 of FIG. 3. Referring to FIG. 4, in step S41, the processor 41 acquires a date (year-month-day-time), the number of times of play, a number of steps, an insect list and field information, from the provider's terminal 75 to be described below. The field information is a list of the valid field and the invalid field. And, in step S43, the processor 41 generates a random number by using the date (year-month-day) received from the provider's terminal as a seed, and assigns a combination of the insect-habitation field 15 and the adjacent field 13 to each valid field.

Specifically, as follows. In the present embodiment, there are five kinds of the insect-habitation fields 15, such as a mountain, a forest, a grassland, a river and a pond. And “i” kinds of the insects are assigned to the mountain, “j” kinds of the insects are assigned to the forest, “k” kinds of the insects are assigned to the grassland, “m” kinds of the insects are assigned to the river, and “n” kinds of the insects are assigned to the pond. Incidentally, male or female are not distinguished on the calculation of such kinds. In this case, a number Nr (p) which represents the number of each insect-habitation field 15 which is assigned to the valid field can be expressed as Nr (p)=(p*M)/(i+j+k+m+n). An invariable “M” is the number of the valid field. And invariable “p” is the number of the kinds of the insects assigned to corresponding insect-habitation fields 15 (“i”, “j”, “k”, “m” or “n”),In this way, the processor 41 assigns each insect-habitation field 15 to the valid field according to the habitation ratio of the insect.

This assignment is performed by generating the random number by using the date as the seed. Because each real field is assigned peculiar identification information (hereinafter referred to as the “real ID”), the valid field also has the real ID. The processor 41 associates the real IDs with consecutive numbers, and makes a list. Then the processor 41 generates a random number in the range of the consecutive numbers by using the date as the seed, refers to the list, and assigns the mountain to the valid field which has the real ID related to the same number as the generated random number.

And after the processor 41 finishes one assignment, the processor 41 makes new list which relates the real ID (except the one which has been already assigned) to the consecutive numbers. Then the processor 41 generates a random number in the range of new consecutive numbers, refers to new list, and assigns the mountain to the valid field which has the real ID related to the same number as the generated random number.

In this way, the processor 41 makes new list while removing the real ID which has been already assigned. And the processor 41 assigns the mountain to the valid field with generating the random number in each time. As far as the date is same, the random number of the “R”-th generation (“R” is an integer not less than one) will be the same value. Therefore, the insect-habitation field 15 which is assigned to each valid field becomes same among the players who play on the same date.

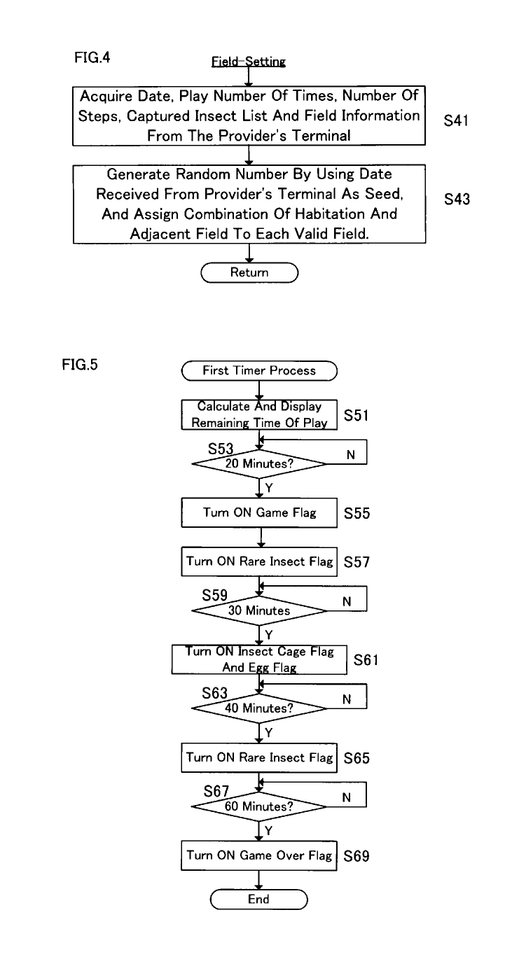

FIG. 5 is the flowchart showing an example of a flow of the first timer process which the processor 41 of FIG. 2B performs. Referring to FIG. 5, in step S51, the processor 41 refers to the first timer which has been started in step S3, calculates the remaining time of the play, and displays it on the display 3. In step S53, the processor 41 determines whether or not twenty minutes passed from the start of the play. If not passed, the processor 41 returns to step S53. Or, if passed, the processor 41 proceeds to step S55.

In step S55, the processor 41 turns on a game flag. The game flag is a flag indicating whether or not the game process is feasible in the barren field 11. Therefore, the game flag is turned on when twenty minutes pass from the start of the play and the game process becomes a feasible state. In step S57, the processor 41 turns on a rare-insect flag. The rare-insect flag is a flag indicating whether or not the insect image 7 corresponding to the rare insect may appear on the screen. Therefore, the rare-insect flag is turned on when twenty minutes pass from the start of the play and the insect image 7 corresponding to the rare insect may appear thereafter.

In step S59, the processor 41 determines whether or not thirty minutes passed from the start of the play, and if not passed, the processor 41 returns to step S59, and if passed, the processor 41 proceeds to step S61. In step S61, the processor 41 turns on an insect cage flag and an egg flag. The insect cage flag is the flag indicating whether or not a predetermined comment may be displayed on the screen. Therefore, the insect cage flag is turned on when thirty minutes pass from the start of the play and such predetermined comment may be displayed thereafter. The egg flag is a flag indicating whether or not an egg image corresponding to a egg of the insect may appear. Therefore, the egg flag is turned on when thirty minutes pass from the start of the play and the egg image may appear thereafter.

In step S63, the processor 41 determines whether or not forty minutes passed from the start of the play, and if not passed, the processor 41 returns to step S63, and if passed, the processor 41 proceeds to step S65. In step S65, the processor 41 turns on the rare-insect flag again.

In step S67, the processor 41 determines whether or not sixty minutes passed from the start of the play, and if not passed, the processor 41 returns to step S67, and if passed, the processor 41 proceeds to step S69. In step S69, the processor 41 turns on the game-over flag in order to finish the play.

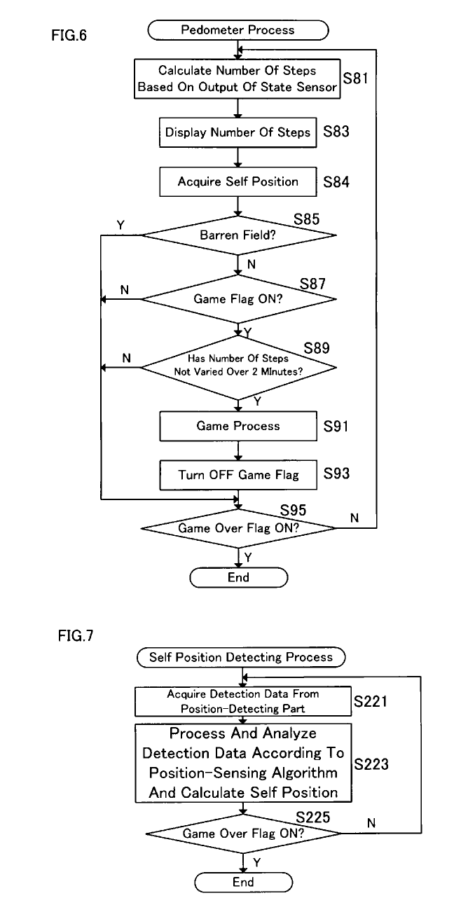

FIG. 6 is the flowchart showing an example of a flow of the pedometer process which the processor 41 of FIG. 2B performs. The processor 41 starts the processes of FIG. 6 in response to the start of the pedometer process of step S5. Referring to FIG. 6, in step S81, the processor 41 processes and analyzes acceleration information from the state sensor 47 that is the triaxiality acceleration sensor according to a widely-known step-measuring algorithm, and detects the steps of the player and calculates number of the steps. And, in step S83, the processor 41 displays the current steps on the display 3.

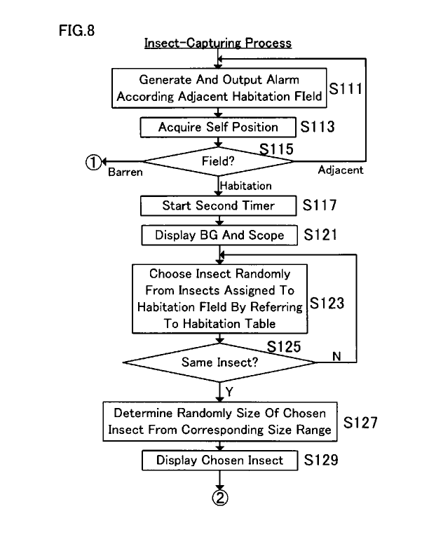

In step S84, the processor 41 acquires the position of the mobile handheld terminal 1 calculated in the position-detecting process of FIG. 7. In step S87, the processor 41 determines whether or not the mobile handheld terminal 1 is located in the barren field 11, and if located, the processor 41 proceeds to step S95, and if not located, the processor 41 proceeds to step S87. In step S87, the processor 41 determines whether or not the game flag (step S55) is ON, and if OFF, the processor 41 proceeds to step S95, and if ON, the processor 41 proceeds to step S89. In step S89, the processor 41 determines whether or not the number of the steps has not varied over two minutes in succession, and if varied, the processor 41 proceeds to step S95, and if not varied, the processor 41 proceeds to step S91.

In step S91, the processor 41 performs the game process, and displays corresponding video image on the display 3, and outputs corresponding sound to the speaker 27. And in step S93, the processor 41 turns off the game flag when the game process is finished.

In step S95, the processor 41 determines whether or not the game-over flag is ON, and if OFF, the processor 41 proceeds to step S81, and if ON, the processor 41 finishes the process.

In the present embodiment, a first game program and a second game program are stored in the external memory 43. Therefore, in step S91, the processor 41 performs either one of the game programs. Next, those programs will be explained.

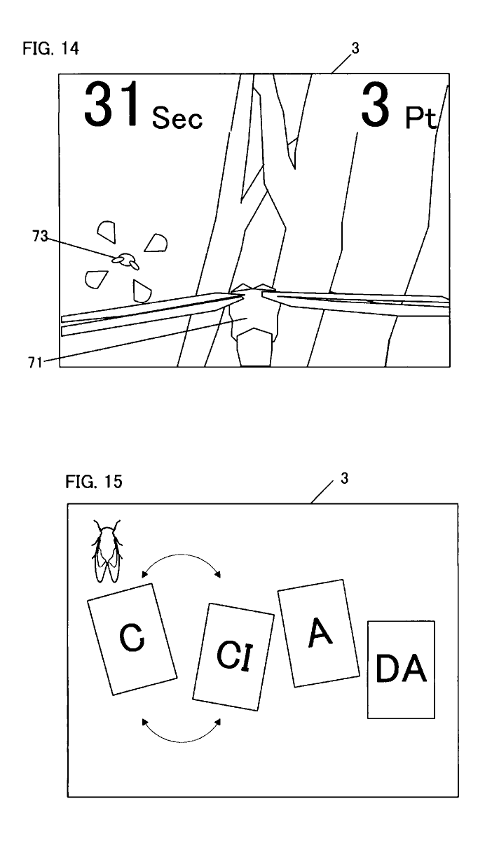

FIG. 14 is the explanatory view of the first game program performed by the game process of step S91 of FIG. 6. Referring to FIG. 14, the first game program displays a dragonfly object 71 and a mosquito object 73 flying in a forest in the virtual space on the display 3. The dragonfly object 71 goes ahead through the forest towards the depths of the screen. And mosquito object 73 appears in the forest and flies about.

Next, a coordinate system will be explained. Referring to FIG. 1, a Z-axis is an axis that is perpendicular to the display 3, a Y-axis is an axis that is parallel with the surface and the narrow side of the display 3, and X-axis is an axis that is perpendicular to the Z-axis and Y-axis.

By the way, the mobile handheld terminal 1 changes the viewpoint of the dragonfly object 71 depending on its posture. For example, when the mobile handheld terminal 1 detects a X-axis rotation by the state sensor 47, the mobile handheld terminal 1 controls the viewpoint of the dragonfly object 71 upward or downward according to its rotatory direction and quantity. For another example, when the mobile handheld terminal 1 detects a Z-axis rotation by the state sensor 47, the mobile handheld terminal 1 controls the viewpoint of the dragonfly object 71 leftward or rightward according to its rotatory direction and quantity.

Therefore, the player tries to move the dragonfly object 71 on the mosquito object 73 timely by adjusting the posture of the mobile handheld terminal 1. If the dragonfly object 71 is located on the mosquito object 73 timely, that is, if it the dragonfly captures the mosquito, the processor 41 gives one point to the player, and displays the acquired points on the display 3. And the processor 41 displays the new mosquito object 73 in the forest on the display 3. In addition, the processor 41 displays the new mosquito object 73 when the player cannot move the dragonfly object 71 on the mosquito object 73 timely. A player tries to capture the mosquito objects 73 as much as possible.

In the present embodiment, a game time is 60 seconds, and the remaining game time is displayed on the display 3. In addition, when the dragonfly object 71 collides to a displayed tree, the going of the dragonfly object 71 is late, therefore numbers of the mosquito object 73 which the player can capture decrease. Therefore, the player makes the dragonfly object 71 go ahead while adjusting the posture of the mobile handheld terminal 1 so that the dragonfly object 71 does not collide to the tree.

FIG. 15 is the explanatory view of the second game program performed by the game process of step S91 of FIG. 6. Referring to FIG. 15, the second game program displays plural letters with a random order on the display 3. A player sorts the letters so that they become a name of the insect displayed on the display 3, by operating the arrow keys 21 and switches 23. In the present embodiment, the time to answer is set as 30 seconds per one question, and the remaining time is displayed on the display 3. Whether the answer is correct or incorrect, whenever one question finishes, an image and an explanation about the insect of the correct answer is displayed on the display 3.

FIG. 7 is the flowchart showing an example of a flow of the position-detecting process which the processor 41 of FIG. 2B performs. The processor 41 starts the processes of FIG. 7 in response to the start of the position-detecting process of step S7. Referring to FIG. 7, in step S221, the processor 41 acquires detection data from the position-detecting part 45. And in step S223, the processor 41 processes and analyzes the detection data according to widely known position-sensing algorithm and calculates the position of the mobile handheld terminal 1. In step S225, the processor 41 determines whether or not the game-over flag is ON, and if OFF, the processor 41 returns to step S221, and if ON, the processor 41 finishes the process.

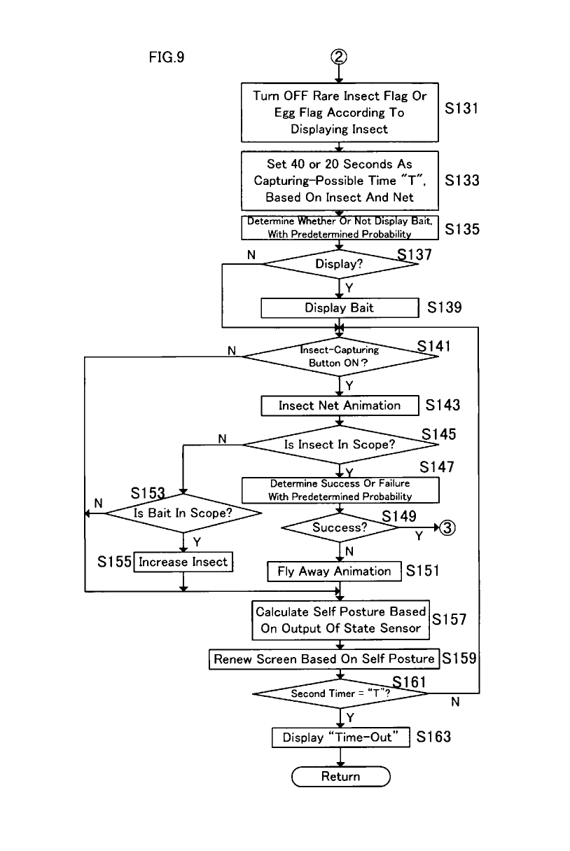

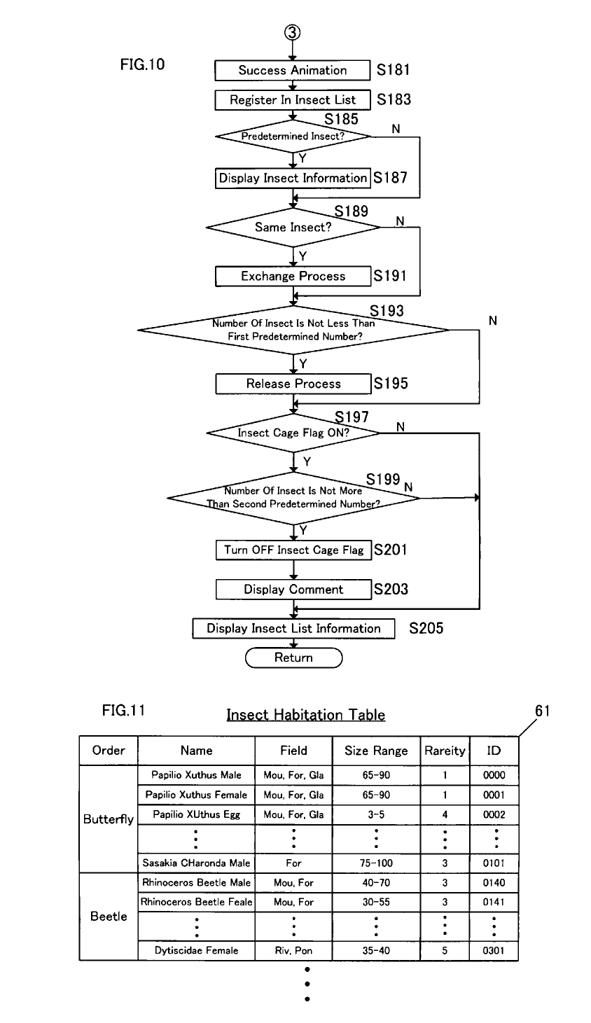

FIG. 8, FIG. 9 and FIG. 10 are the flowcharts showing examples of the insect-capturing process of step S11 of FIG. 3. In FIG. 1, the processor 41 determines that the insect is captured when the insect image 7 goes into the scope 5. On the other hand, in the following description, the processor 41 considers that the insect is captured when the predetermined switch 23 is turned ON in the state that the insect image 7 is located in the scope 5.

Referring to FIG. 8, in step S111, the processor 41 generates the alarm according to the insect-habitation field 15 corresponding to the adjacent field 13 where the mobile handheld terminal 1 is located, and the processor 41 gives it to the speaker 27. Incidentally, the alarms are different in each of the mountain, the forest, the grassland, the river and the pond.

In step S113, the processor 41 acquires the position of the mobile handheld terminal 1 calculated in the position-detecting process of FIG. 7. In step S115: if the mobile handheld terminal 1 remains in the adjacent field 13, the processor 41 returns to step S111; if the mobile handheld terminal 1 is located in the insect-habitation field 15, the processor 41 proceeds to step S117; or if the mobile handheld terminal 1 is out of the adjacent field 13 and is located in the barren field 11, the processor 41 proceeds to step S15 of FIG. 3.

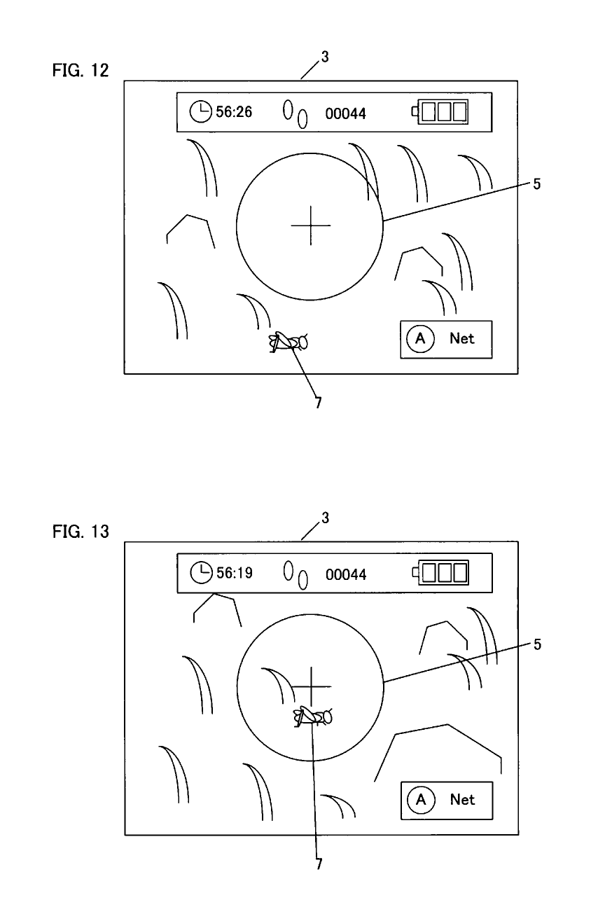

In step S117, the processor 41 starts the second timer. In this way, the second timer starts when the mobile handheld terminal 1 goes into the insect-habitation field 15, and measures time “T” which is set for the capture of the insect (hereinafter referred to as the “capture-possible time “T””). In step S121, the processor 41 displays on the display 3: the scope 5; and the background image corresponding to the present insect-habitation field. For example, as shown in FIG. 12, the processor 41 displays the background image and the scope 5 on the display 3.

In step S123, the processor 41 chooses, by referring to the insect-habitation table 61 of FIG. 11, the insect at random from the insects assigned to the insect-habitation field 15 where the mobile handheld terminal 1 is located.

FIG. 11 is the example view of the insect-habitation table 61 stored in the external memory 43 of FIG. 2B. Referring to FIG. 11, the insect-habitation table 61 is the table which connected an order which the insect belongs to, a name of the insect, the insect-habitation field 15, a size range of the insect, a rarity of the insect and an ID of the insect.

In the present embodiment, the rarity of the insect is expressed with five levels from one to five, and the bigger the number is, the higher the rarity is. The insect whose rarity is “5” is referred to as the rare insect. The processor 41 performs a random choice from candidates including the rare insect only when the rare-insect flag (step S57, S65) is ON.

In addition, the egg of the insect is treated the same as the insect, and is listed in the insect-habitation table 61. However, only when the egg flag (step S61) is ON, the processor 41 treats the egg the same as the insect and performs random from candidates including the egg.

Returning to FIG. 8, in step S125, the processor 41 determines, with referring to the insect list stored in the external memory 43, whether or not the insect chosen in step S123 is the same as the insect which has been already captured, and if it is the captured insect, the processor 41 returns to step S123, or if not, the processor 41 proceeds to step S127.

In step S127, the processor 41 determines at random, by referring to the insect-habitation table 61, the size from the size range corresponding to the chosen insect. And, in step S129, the processor 41 keeps the determined size, and displays the insect image 7 corresponding to the chosen insect on the display 3, and proceeds to step S131 of FIG. 9. For example, as shown in FIG. 12, the processor 41 displays the insect image 7 so that it is located outside scope 5, on the display 3.

Incidentally, when the egg is chosen, the egg image corresponding to the egg is displayed. Hereinafter, this egg image shall be explained as one of the insect image 7 because it is treated the same as the insect as described above.

Referring to FIG. 9, in step S131, in the case where the displayed insect image 7 corresponds to the rare insect, the processor 41 turns off the rare-insect flag, or in the case where the displayed insect image 7 is the egg image, the processor 41 turns off the egg image. In other cases, the processor 41 skips step S131.

In step S133, the processor 41 sets forty seconds or twenty seconds as the capturing-possible time “T”, on the basis of a property of the (virtual) set insect net and the position of the insect corresponding to the displayed insect image 7. For example, when the length of the set insect net is too short to reach to the insect, the processor 41 sets the capturing-possible time “T” as twenty seconds, and when the length of the set insect net is enough long to reach to the insect, the processor 41 sets the capturing-possible time “T” as forty seconds.

In step S135, the processor 41 determines whether or not it displays a bait object on the basis of a predetermined probability. In step S137, when the processor 41 determines to display the bait object, it proceeds to step S139, or when the processor 41 determines not to display the bait object, it proceeds to step S141. In step S139, the processor 41 displays the bait object on the display 3. For example, the bait object moves from the left to the right while shaking up and down, and then goes out.

In step S141, the processor 41 determines whether or not a insect-capturing button is turned ON, and if ON, the processor 41 proceeds to step S143, or if OFF, the processor 41 proceeds to step S157. For example, the rightmost switch 23 is assigned to the insect-capturing button. In step S143, the processor 41 displays the animation indicating that the insect net moves, on the display 3.

In step S145, the processor 41 determines whether or not the insect image 7 is located in the scope 5, and if not in, the processor 41 proceeds to step S145, or if in, the processor 41 proceeds to step S147. For example, if the insect-capturing button is pushed when the insect image 7 is located in the scope 5 as shown in FIG. 13, the processor 41 proceeds to step S147.

In step S147, the processor 41 determines whether the capture is success or failure, with a predetermined probability. In step S149, when the processor 41 determines the success, it proceeds to step S181 of FIG. 10, or when the processor 41 determines the failure, it proceeds to step S151. In step S151, the processor 41 displays the animation indicating that the insect image 7 flies away, on the display 3.

On the other hand, in step S153, the processor 41 determines whether or not the bait object is located in the scope 5, and if not in, the processor 41 proceeds to step S157, or if in, the processor 41 proceeds to step S155. In step S155, the processor 41 increases numbers of the displaying insect image 7, and proceeds to step S157.

In step S157, the processor 41 receives the output data of the state sensor 47, and processes and analyzes such data according to a widely known posture-detecting algorithm, and calculates the posture of the mobile handheld terminal 1. In step S159, the processor 41 scrolls the background image and the insect image 7 depending on the posture of the mobile handheld terminal 1. (Control of Event Process)

In step S161, the processor 41 determines whether or not the value of the second timer corresponds with the capturing-possible time “T”, and if does not correspond, the processor 41 returns to step S141, or if corresponds, the processor 41 proceeds to step S163. In the display 3, the processor 41 displays an indication of time-out, and returns.

After having determined that the capture is success in step S149, in step S181 of FIG. 10, the processor 41 displays the animation indicating the insect image 7 is captured by the insect net, on the display 3. In step S183, the processor 41 registers the insect corresponding to the captured insect image 7 to the insect list. The registration to the insect list corresponds to the putting the insect into the insect cage.

In step S185, if the insect captured in this time is a predetermined insect, the processor 41 proceeds to step S187, otherwise the processor 41 proceeds to step S189. In step S187, the processor 41 displays information about the predetermined insect on the display 3.

In step S189, the processor 41 determines, with referring to the insect list, whether the insect captured in this time is the same as the insect which has been already captured, and if same, the processor 41 proceeds to step S191, otherwise, the processor 41 proceeds to step S193. In step S191, the processor 41 displays the video image recommending the exchange of the insect captured this time and other insect on the display 3, and depending on operation of a player, the processor 41 determines whether or not the exchange is done.

In step S193, the processor 41 determines whether or not the number of the insect registered in the insect list in this play is a first predetermined number, if it is the first predetermined number, the processor 41 proceeds to step S195, otherwise, the processor 41 proceeds to step S197. The first predetermined number is the upper limit of the number of the insect which can be registered in the insect list in this play. In step S195, the processor 41 displays a video image recommending deleting one from the insects which have been registered in the insect list in this play and the insect captured in this time. The processor 41 deletes the insect chosen by a player from the list, depending on an operation of a player. In other words the processor 41 releases the chosen insect.

In step S197, the processor 41 determines whether or not the insect cage flag (step S55) is ON, and if ON, the processor 41 proceeds to step S199, or if OFF, the processor 41 proceeds to step S205. In step S199, the processor 41 determines whether or not the number of the insect registered in the insect list in this play is not more than the second predetermined number, and if not more than the second predetermined number, the processor 41 proceeds to step S201, otherwise, the processor 41 proceeds to step S205. In step S201, the processor 41 turns OFF the insect cage flag. In step S203, the processor 41 displays the comment stored in the external memory 43 on the display 3.

In step S205, the processor 41 displays information of the insect registered with the insect list on the display 3, and returns.

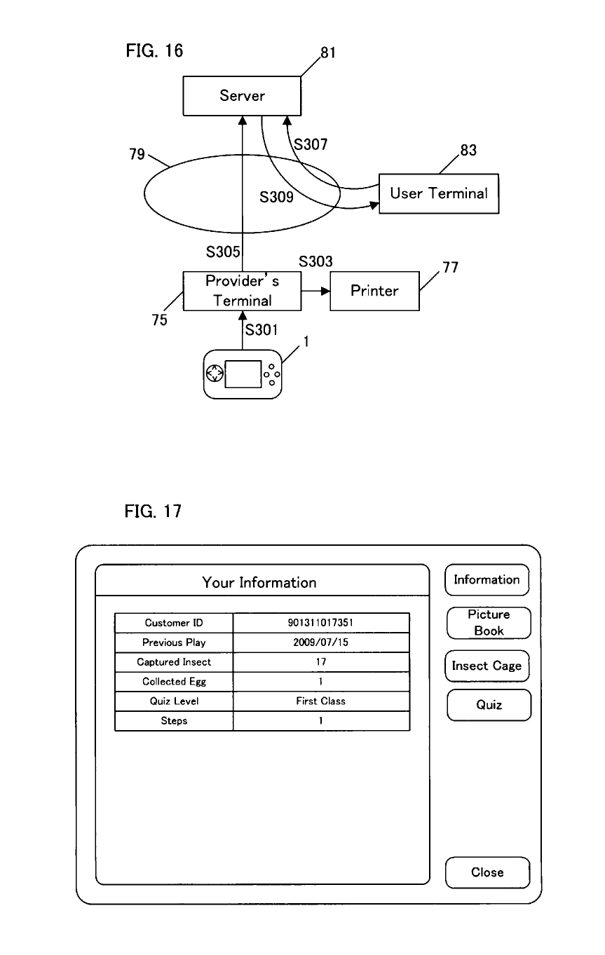

FIG. 16 is the diagram showing an example of the content-providing system using the capturing-game system of the present embodiment. Referring to FIG. 16, in step S301, the mobile handheld terminal 1 transfers the insect list to the provider's terminal 75 after the game-over. In step S303, the provider's terminal 75 outputs the image and the name of the insect registered in the insect list in this play to the printer 77 and prints them.

In addition, in step S305, the provider's terminal 75 transmits the insect list to the server 81 through network 79. The server 81 associates the received insect list with identification information (player ID) of a player and stores it.

When the user terminal 83 accesses the server 81 in step S307, the server 81 transmits the predetermined WEB site to the user terminal 83 in step S309. When the user terminal 83 inputs the player ID from this WEB site, the server 81 performs log-in process and transmits contents (WEB pages) based on the insect list corresponding to the player ID to the user terminal 83. In this way, a user of the user terminal 83, that is, the player can see or download richer information about the insect that he captured than the information that is provided by the mobile handheld terminal 1.

In what follows, the contents that the server 81 provides to the user terminal 83 will be explained in conjunction with the accompanying drawings.

FIG. 17 is the example view of the information screen of the WEB site provided to the user terminal 83 from the server 81 of FIG. 16. Referring to FIG. 17, when the player ID is input from the user terminal 83, the information screen is displayed on a display of the user terminal 83. The information screen displays: the player ID; a date of a previous play; number of the insect and the egg which a user having such player ID captured; information of a level of a quiz; and the number of the steps.

In addition, in the right area of this screen, an “information” button, a “picture book” button, an “insect cage” button, a “quiz” button and a “close” button are displayed. When the “information” button is clicked, the information screen of FIG. 17 is displayed, and when the “picture book” button is clicked, the picture book screen of FIG. 18 is displayed, and when the “insect cage” button is clicked, the insect cage screen of FIG. 20 is displayed, and when the “quiz” button is clicked, the quiz screen of FIG. 22 is displayed, and when the “close” button is clicked, a log-out process is performed. Incidentally, these buttons are also displayed in the picture book screen, the insect cage screen and the quiz screen, and each button has the same function on each screen.

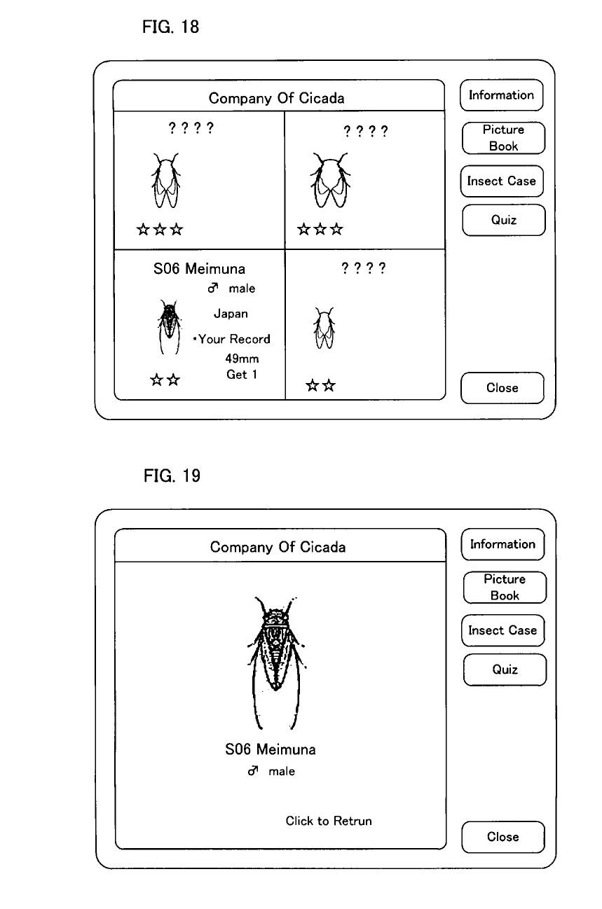

When the “picture book” button is clicked in any screens, the picture book screen of FIG. 18 is displayed. The picture book screen displays the name, the image and the rarity of the insect and other information about the captured insect (e.g. male or female, season, habitat, size and number of times of the capture). When the image of the insect is clicked on this screen, the extended image of the insect is displayed as shown in FIG. 19.

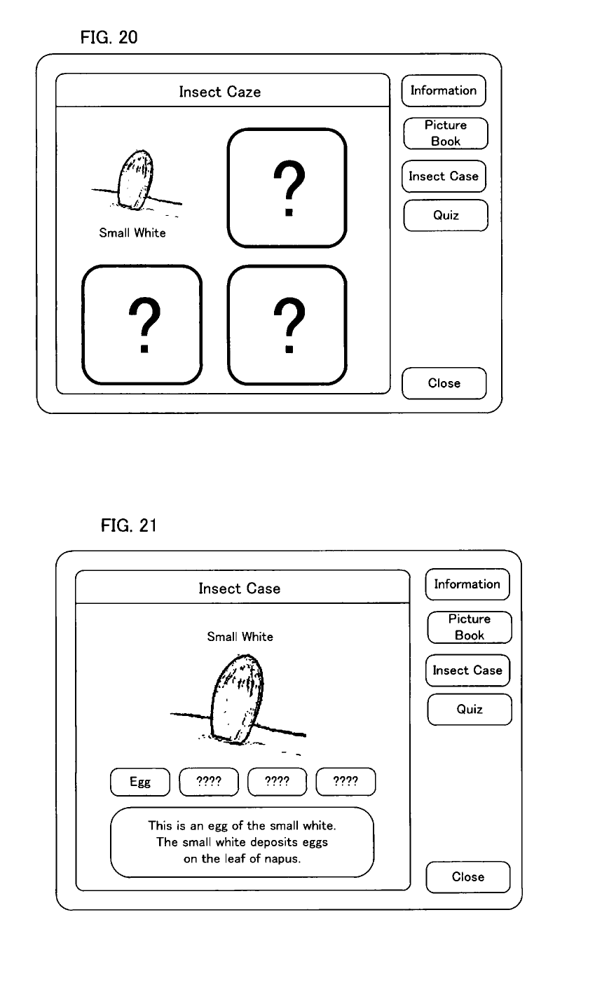

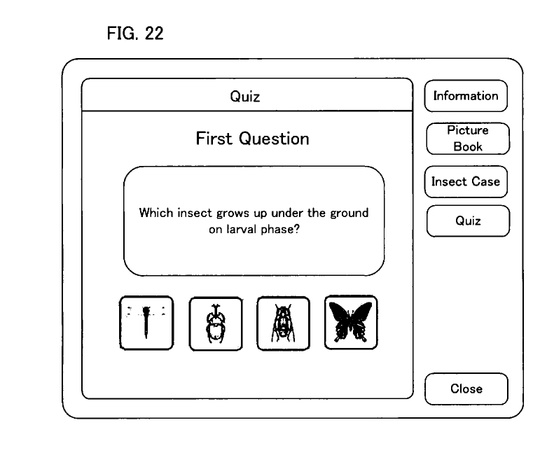

In addition, when the “insect cage” button is clicked on any screens, the insect cage screen of FIG. 20 is displayed. This screen includes image of the captured egg and the name of the imago of such egg. When the image of the egg is clicked on this screen, the extended image of the egg and its explanation are displayed as shown in FIG. 21.

Incidentally, the server 81 hatches the egg, and gradually changes it to larva, pupa, and imago, depending on elapse of time. Therefore, the contents of the insect cage screen change depending on elapse of time.

Furthermore, the quiz screen of FIG. 22 is displayed when the “quiz” button is clicked on the any screen. This screen displays the quiz about the insect. The user operates the user terminal 83 and answers this quiz.

Returning to FIG. 16, the provider's terminal 75 transfers the field information to the mobile handheld terminal 1 at the time of the start of the play, as described above. Therefore, the place of the virtual field to set in the mobile handheld terminal 1 can be changed by changing contents of the field information (the valid field and the invalid field) on the provider's terminal 75.

For example, depending on a real environment of the place where the play area 9 is placed, it is possible to increase the valid field and decrease the invalid field, or it is possible to decrease the valid field and increase the invalid field, or it is possible to change an alignment of the valid field and invalid field. In this way, the place of the virtual field to set in the mobile handheld terminal 1 is changed. This is because the virtual field is assigned to the valid field.

By the way, as described above, according to the present embodiment, the progress of the event which is performed when the mobile handheld terminal 1 is located in the predetermined field is controlled based on the state of the mobile handheld terminal 1 in three-dimensional space. In this embodiment, predetermined field is the insect-habitation field, the event is insect-capturing process which is one of the game processes, and the status is the posture. In other words, the player or the user can control the progress of the event which is performed in the predetermined field, by moving the mobile handheld terminal 1 or changing the posture of it. As a result, it is possible to provide content which is according to the self-position, and it is hard to get tired and is enough fun as game or an entertainment than in the case where the mobile handheld terminal cannot control the event or in the case where it can control the event but is operated in a resting state.

Meanwhile, the present invention is not limited to the above embodiments, and a variety of variations and modifications may be effected without departing from the spirit and scope thereof, as described in the following exemplary modifications.

(1) In the above description, the state sensor 47 performs both of the measurement of the steps and the measurement of the posture measurement of the mobile handheld terminal 1. However, it is also possible to provide separately a state sensor measuring the steps and another state sensor measuring the posture. In addition, in the above description, the steps are measured. However, it may be measured, a calorie consumption, an active mass, a heartbeat, an exercise strength or any combination of them.

Incidentally, the active mass (Ex) is the value multiplying the exercise strength (Mets) by time (hour). This exercise strength is determined according to an exercise form. In addition, the exercise strength is expressed with three kinds of indexes (a physical strength index, a physiological strength index, a psychological strength index) mainly. For example, with the physical strength index, the exercise strength is defined as one watt in the case where it works one joule per second. A physiological strength index includes an oxygen intake and a heart rate. For example, it is known to be able to define as “the exercise strength =the oxygen intake/the maximum oxygen intake”. For example, it is known to be able to define as “the exercise strength =the oxygen intake/(the maximum oxygen intake-the oxygen intake at rest)”. For example, it is known to be able to define as “the exercise strength=the heart rate/the maximum heart rate”. For example, it is known to be able to define as “the exercise strength =(the heart rate-the heart rate at rest)/(the maximum heart rate - the heart rate at rest). It is known to be able to guess the maximum heart rate as “220-age”. The psychological strength index is an index using subjective fatigue. Incidentally, in the present embodiment, the psychological strength index is not used.

(2) The play area 9 may be one layer or multiple layers (e.g. multiple layers placed in a vertical direction). In addition, the play area 9 may be placed in indoor, outdoors or both of indoors and outdoors.

For example, the play area 9 is placed in indoors. And for example, the play area 9 is set in a commercial facility such as a shopping mall. In this case the play area 9 is set in each floor of the commercial facility.

(3) Although it is in the play area 9, there are some areas where it is inappropriate to play, or where the provider does not want players to play. In addition, it is also necessary to alert a player so that such player does not go out from the play area 9. In this case, the valid field is set in such areas, and when the mobile handheld terminal 1 is located in such areas, an alert message may be provided by the display 3 and the speaker 27.

For example, in the case where the play area 9 is placed in a commercial facility, the valid fields are placed in a restroom, a food department, and an entrance. And when the mobile handheld terminal 1 is located in the valid field including the restroom, a first advice (e.g. text such as “The insect is not in the restroom!”) is displayed on the display and/or outputs a sound from the speaker 27. And when the mobile handheld terminal 1 is located in the valid field including the food department, a second advice (e.g. text such as “The insect is not in the food department!”) is displayed on the display and/or outputs a sound from the speaker 27. Further when the mobile handheld terminal 1 is located in the valid field including the entrance, a third advice (e.g. text such as “The insect is not in the outdoors!”) is displayed on the display and/or outputs a sound from the speaker 27.

For example, the present invention is available for an entertainment industry such as games which is performing events depending on a position of the mobile handheld terminal. While the present invention has been described in terms of embodiments, those skilled in the art will recognize that the invention is not limited to the embodiments described. The present invention can be practiced with modification and alteration within the spirit and scope of the appended claims. The description is thus to be regarded as illustrative instead of limiting in any way on the present invention.

What is claimed is:

1. A mobile handheld terminal comprising:
a state detecting unit operable to detect a state of the mobile handheld terminal in three-dimensional space;
a position-detecting unit operable to detect a position of the mobile handheld terminal;
a determining unit operable to determine whether or not the detected position exists in the predetermined field; and
an event performing unit operable to perform an predetermined event and to control progress of the predetermined event on the basis of the state of the mobile handheld terminal, in the case where the determining unit determines that the detected position exists in the predetermined field.

2. The mobile handheld terminal as claimed in claim 1, further comprising a displaying unit,
and wherein the event performing unit performs a game which displays video image on the displaying unit as the event, and controls progress of the game on the basis of the state of the mobile handheld terminal.

3. The mobile handheld terminal as claimed in claim 2,
wherein the game is a game to capture a virtual subject assigned to the predetermined field, and
wherein the event performing unit displays an image representing the virtual subject on the displaying unit, and determines on the basis of the state of the mobile handheld terminal whether or not the virtual subject is captured.
